(19) United States
(12) Patent Application Publication
(10) Pub. No.: US 2006/0184883 A1
(43) Pub. Date: Aug. 17, 2006

(54) System and method for linking workflow to user input via a portal

(75) Inventors: Stanley K. Jerrard-Dunne, Dublin (IE); Ralf Heindoerfer, Paderborn (DE)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/209,959

(22) Filed: Aug. 23, 2005

(30) Foreign Application Priority Data
Feb. 12, 2005 (GB) 0502956.6

(51) Int. Cl. G06F 17/00; G06F 9/44; G06F 15/16

(52) U.S. Cl. 715/742; 709/219; 705/7

(57) ABSTRACT

A system and method are provided for linking workflow to user input via a portal application. The system includes a portal application having a plurality of portal pages and a workflow system running a workflow process including a plurality of activities, wherein an activity in the workflow process is linked to a portal page. A portal page has a user input portlet for inputting a result of the activity linked to the portal page. Means are provided for returning the result to the workflow system to determine the next activity in the workflow process. The user input portlet in a portal page includes means for inputting one or more property values relating to the activity linked to the portal page. The property values can be transferred between two or more portal pages relating to different activities via the workflow system.

### BACKGROUND OF THE INVENTION

1. Field of the Invention

This invention relates to the fields of portals and portlets in combination with workflow processes. In particular, the present invention relates to linking workflow to user input via a portal.

2. Background of the Invention

A portal provides a means of displaying web content to users. A portal may be defined as an application which provides a secure, single point of interaction with diverse information, business processes, and people. A portal server (for example, WebSphere Portal, WebSphere is a trade mark of International Business Machines Corporation) includes a portal application which arranges web content into portal pages.

Each portal page may contain one or more portlets. Each portlet includes a section of web content to meet the requirements of the portal page user. The portal application obtains the desired web content from an appropriate content provider, aggregates the web content, and then displays the web content in the appropriate portlets of the portal page. Portlets are pluggable components that can be added to portals and are designed to run inside a portal's portlet container. Portlets may provide different functions ranging from simple rendering of static or dynamic content to application functions such as e-mail, calendar, etc.

Existing workflow systems (for example, WebSphere Application Server Process Choreographer) manage lists containing work items, which represent work tasks that have to be performed by a user. The workflow system determines the users that are capable of performing the work and assigns work items to the user's task lists.

A workflow system may be defined as an application which provides automation of a business process, in whole or in part, during which documents, information or tasks are passed from one participant to another for action, according to a set of procedural rules. While a workflow system provides means to pass information and tasks to persons, a portal may be used to provide personalized presentation of this information and the applications required to perform the tasks.

US 2004/0133660 discloses a method and system for dynamically assembling a portal page which provides the function to manipulate the whole topology tree of a portal at runtime. The dynamic assembly is determined in response to some external stimuli. In one described embodiment, a workflow is integrated into a portal system using the dynamic assembly. A workflow system builds a topology tree based on the state of the workflow system which is used.

### SUMMARY OF THE INVENTION

The present invention expands the use of workflow systems by linking workflow to user activities via a portal. Users are directed to specific pages within a portal server environment, which contain the tools necessary to input a result for a specific task of a workflow process. The next step of the workflow process is determined by the user input result.

Specific users associated with a task are directed to the correct tools to provide the mechanism to complete the job; data is passed from task to task and user to user in order to complete a workflow process.

According to a first aspect of the present invention there is provided a system for linking workflow to user input via a portal application, comprising: a portal application having a plurality of portal pages; a workflow system running a workflow process comprising a plurality of activities, wherein an activity in the workflow process is linked to a portal page; a portal page having a user input portlet for inputting a result of the activity linked to the portal page; and means for returning the result to the workflow system to determine a next activity in the workflow process.

A portal page preferably includes one or more portlets relating to the linked activity.

The workflow system may have a mapping means for mapping a result to the next activity in the workflow process.

The user input portlet in a portal page may include means for inputting one or more property values relating to the activity linked to the portal page. The user input portlet may include means for transferring the property values to the workflow system. Means may also be provided for sharing the property values between the user input portlet and one or more other portlets in the portal page. A user input portlet in a portal page may include means for receiving property values from the workflow system. The property values may be transferred between two or more portal pages relating to different activities via the workflow system. The property values may be validated and enforced by a result input by the user.

An activity may be linked to more than one portal page, with one designated linked portal page for the activity.

An activity in the workflow process may have a Uniform Resource Locator (URL) to a portal page.

An activity in the workflow process may be assigned to a user or a group of users. The workflow system may include a notification means for notifying the assigned user or group of users of the activity to be performed.

The user input portlet may include a visual indication of the position of the activity in the workflow process.

The user input portlet may also include means to configure the portlet to provide results for the linked activity.

The workflow process may include a means for administrating the workflow process. The means for administrating the workflow process may includes a user input portlet for inputting administration commands to the workflow system.

According to a second aspect of the present invention there is provided a method for linking workflow to user input via a portal application, the portal application having a plurality of portal pages, the method comprising: providing a workflow process in a workflow system; linking an activity in the workflow process to a portal page; inputting a result of the activity via a user input portlet in the portal page; returning the result of the activity to the workflow system; and determining a next activity in the workflow process based on the returned result.

The method may include mapping a result to the next activity in the workflow process.

The method may further include inputting one or more property values relating to the activity via the user input portlet. The property values may be transferred from the user input portlet to the workflow system, shared between the user input portlet and one or more other portlets in the portal page, received from the workflow system at a user input portlet in a portal page, and transferred between two or more portal pages relating to different activities via the workflow system. The property values may be validated and enforced by a result input by the user.

An activity may be linked to more than one portal page with one designated linked portal page for the activity.

The method may include assigning one or more users to an activity and notifying the one or more users of an activity to be performed.

The method may also include configuring the user input portlet to provide results for the linked activity.

The method may also include administrating the workflow process via a user input portlet, wherein administrating the workflow process includes inputting administration commands to the workflow system.

According to a third aspect of the present invention there is provided a computer program product stored on a computer readable storage medium for linking workflow to user input via a portal application, the portal application having a plurality of portal pages, comprising computer readable program code means for performing the steps of: providing a workflow process in a workflow system; linking an activity in the workflow process to a portal page; inputting a result of the activity via a user input portlet in the portal page; returning the result of the activity to the workflow system; and determining a next activity in the workflow process based on the returned result.

Currently workflow systems typically pass data to a user via a HTML (Hypertext Markup Language) form or similar allowing the user to do some limited work with the data. This improvement provides task execution via portlets on a portal page ensuring that the user has the data in the correct context and has the suite of tools required to perform the task. A process management tool referred to as a dashboard is provided for each activity and that tool provides the user with the ability to indicate when the task is complete.

### BRIEF DESCRIPTION OF THE DRAWINGS

Embodiments of the present invention will now be described, by way of examples only, with reference to the accompanying drawings in which:

FIG. 1 is a block diagram of a computer system on which the present invention may be implemented;

FIG. 2 is a schematic diagram of a workflow linked to pages of a portal in accordance with the present invention;

FIG. 3A shows the fields of an activity of a workflow process in accordance with the present invention;

FIG. 3B is an embodiment of a dashboard for user input of a result of an activity;

FIG. 3C shows the results of the user input in accordance with the present invention;

FIG. 4 is a block diagram of a computer system showing the flow of a property value through the system in accordance with the present invention;

FIG. 5 is an illustrative embodiment of a workflow in accordance with the present invention;

FIG. 6 is a representation of one activity within the workflow of the illustrative embodiment shown in FIG. 5 in accordance with the present invention; and

FIG. 7 is a diagram of a portal page of the illustrative embodiment shown in FIG. 5 in accordance with the present invention.

### DETAILED DESCRIPTION OF THE INVENTION

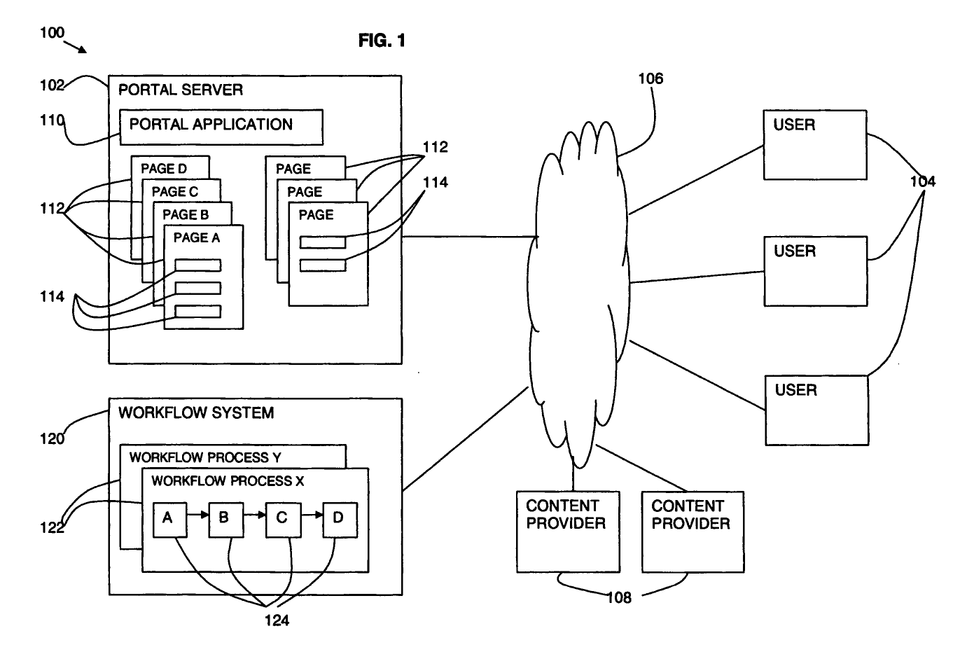

FIG. 1 shows a computer architecture 100 in which the present invention may be implemented. The computer architecture 100 includes a portal server 102 which generally comprises a central processing unit (CPU), memory, input/output interface, bus, input/output devices and database. The portal server 102 is connected to a plurality of user systems 104 via a network 106 (e.g. LAN, WAN, Internet, etc.). The portal server 102 is also connected to one or more content provider systems 108 via the network 106. The user systems 104 and the content provider systems 108 also comprise computer components including CPU and memory, etc.

The portal server 102 includes a portal application 110 which provides portal pages 112 with portlets 114 provided on each portal page 112. A portlet 114 may provide a section of web content as provided by a content provider system 108, or may provide data itself. In this way, a portal page 112 can provide any number of portlets 114 providing web content from multiple providers in a single interface for a user.

A workflow system 120 is also provided in the architecture 100 which provides automation of a workflow process 122, for example a business process. A workflow system 120 defines, creates and manages the execution of workflows through the use of software running on one or more workflow engines. The software is able to interpret the process definition, interact with workflow participants and invoke the use of applications, where required.

Each workflow process 122 includes a list of activities 124 with simple flows. Branching and looping of the flows are available based on the results of an activity 124.

The user systems 104 represent client applications of the workflow system 120 which carry out tasks or activities 124 within a workflow process. The user systems 104 may be connected to the workflow system 120 via a network 106 as shown in FIG. 1, or may be connected directly to the workflow system 120.

The workflow system 120 can end an activity 124 or an activity 124 can be ended by a user inputting a result for the activity 124. For example, the workflow system 120 can close out an activity 124 if that activity 124 has been inactive for a preset time. The inactivity is tracked as a function of an agent running workflow system 120.

An activity 124 can be assigned to an individual user or to a group of users. The workflow system 120 includes a means of notifying the individual user or group of users that they are due to carry out an activity 124 in the workflow process 122. The notifying means can be via an individual's task list, an email or other message. The workflow process 122 is held in a paused state until a result of the activity 124 is received by the workflow system 120.

Each activity 124 in a workflow process 122 has an associated portal page 112 in the portal server 102. For example, in FIG. 1 a workflow process X 122 is shown with activities 124A, B, C and D. Activity 124A has an associated portal page 112A, activity 124B has an associated portal page 112B, etc. When an activity 124 in a workflow process 122 is defined, a URL (Uniform Resource Locator) to a page 112 in the portal server 102 is specified.

The portal page 114 for an activity 124 in a workflow process 122 provides the user 104 who is assigned to carry out the activity 124 a portal page 114 with all the tools necessary to implement the activity 124. The tools are provided in the form of portlets 114 in the portal page 112.

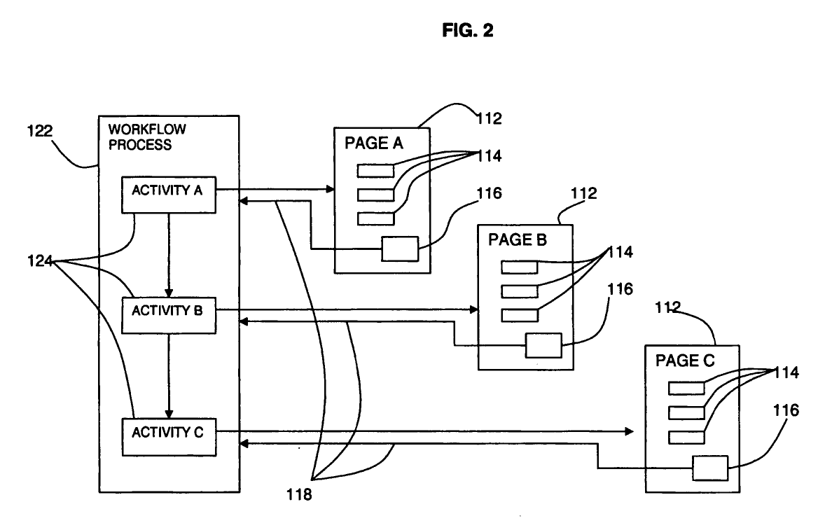

FIG. 2 shows a workflow process 122 with three activities 124, Activity A, Activity B and Activity C. Corresponding portal pages 112, Page A, Page B and Page C are shown. Each page 112 has one or more portlets 114 providing web content for the user to access in order to carry out the activity.

The portal pages 112 also have a result input portlet referred to herein as a dashboard 116 via which the user inputs the result of the activity 124. The result of the activity 124 is returned 118 from the dashboard 116 to the workflow process 122 in order to determine the next step of the flow of the workflow process 122 which is dependent on the result.

A process manager is also provided as a tool used to instantiate an instance of a workflow process 122. The process manager may be implemented as a portlet in a portal page. The process manager is used to track running processes 122 and is a tool to allow administration of processes. For example, the process manager can carry out tasks such as suspending or stopping a process, reassigning a process to another party, etc.

A task list is provided for a user and lists the tasks assigned to a specific user. A task can be a workflow activity or may be some other task such as a “To do” reminder. Tasks assigned to a group should appear in every member's task list. One member of the group may claim and complete the task. From within the task list it is possible for a user to navigate to the relevant page to complete the specific task.

When an individual user claims a task, that task may be removed from the task list of the other group members, or the other group members may be notified via a message.

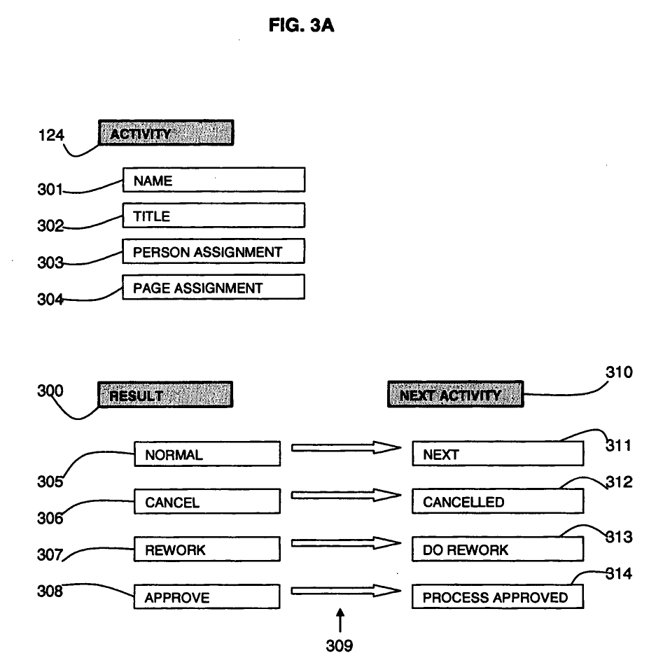

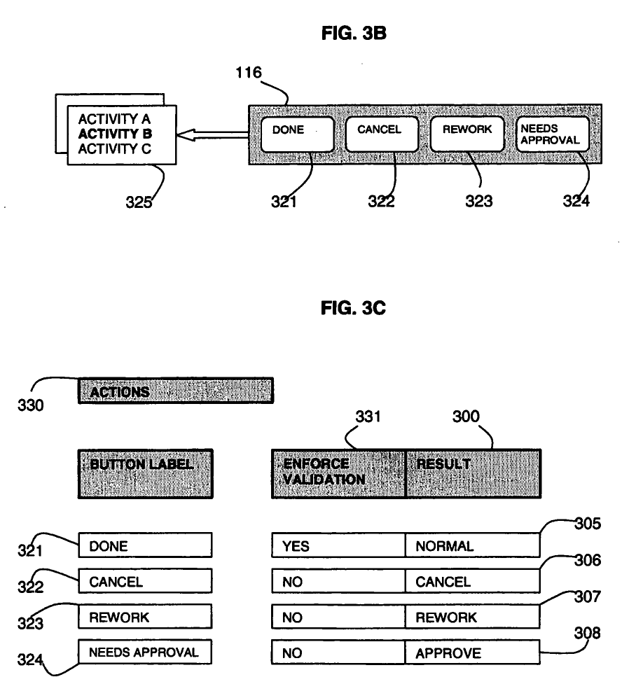

FIG. 3A shows an example of fields associated with an activity 124 in a workflow process. The fields include a name 301 of the activity, a title 302 of the activity, an assignment of a person or group 303 to carry out the activity, and an assignment of a portal page 304 associated with the activity.

The possible results 300 which may be input via the dashboard 116 can be adapted to suit the workflow process and the activity. Example results 300 which may be input include the following fields:
“Normal” 305;
“Cancel” 306;
“Rework” 307; and
“Approve” 308.

Each result 300 has a pointer 309 to a next activity 310 in the workflow process. In the example, the next activities 310 corresponding to the above results 116 are as follows:
“Next” 311;
“Cancelled” 312;
“Do rework” 313; and
“Process approved” 314.

A page 112 in a portal server 102 is associated with an activity 124. There may be a number of pages required for the completion of the activity 124 but the activity 124 is associated to the first page 112. The activity 124 may be completed normally, cancelled or another outcome may be the result. The result of the activity 124 is passed back to the workflow system 120 via the dashboard 116. An instance of a dashboard 116 is required on at least one of the pages for each activity and the dashboard 116 is implemented as a portlet in the portal page 112.

An example dashboard 116 is shown in FIG. 3B. The dashboard 116 contains action buttons 321 to 324 for inputting the result of the activity. In this example, the action buttons correspond to the results 300 shown in FIG. 3A. Each portal page 112 corresponding to an activity 124 may have an individually configured dashboard 116 with action buttons appropriate to the activity 124 corresponding to the portal page 112. The dashboard 116 also provides a visual indication 325 of where the activity 124 currently being processed is in the flow of the workflow process 122.

The dashboard 116 is a configurable portlet with a default configuration of “Done” 321 and “Cancel” 322 actions buttons. Configuration allows action buttons to be added, removed or edited. Actions may provide the workflow process with result values.

FIG. 3C shows the actions 330 with the correlation of the action buttons 321 to 324 to the results 300 as shown in FIG. 3A.

The dashboard 116 also provides a route whereby workflow properties can be passed to and from the workflow system 120 allowing values to be passed from one activity 124 to another.

Values of workflow properties that are defined during an activity 124 can be shared with the portlets 114 in the portal page 112 for the activity 124. The values of the workflow properties can also be output from the dashboard 116 to the workflow system 120. The workflow system 120 can input the values to dashboards 116 in other portal pages 114 relating to other activities 124 in the same workflow process 122.

The dashboard 116 configuration allows values of workflow properties to be defined. Workflow property values are available as both input and output in a cooperative portlet sense. Wires can be created from a portlet to a workflow variable or from a workflow variable to a portlet. A method of sharing portlet data is described in more detail in US 2004/0090969.

In creating a portlet, the data type for each data field is defined (i.e., character, string, real, integer, etc.) within the portlet. The data field is also defined as an input field, an output field, an internal field or an input/output field. Data fields specified as input fields or input/output fields (destination fields) can receive data from another portlet from a content provider system. Data fields specified as output fields or input/output fields (source fields) can share data to another portlet. Data fields specified as internal fields cannot receive or share data with either another portlet or content provider system.

Portlets can be mapped using a mapping system which allows source fields of one portlet to be mapped/linked to destination fields of another portlet. When two fields are mapped, the data in the source filed is automatically shared with the destination field. The mapping system may require a conversion means for converting different data types being shared between portlets. The transfer of data between portlets may be implemented using a messaging system via a broker system or by a shared memory system.

Workflow property values are available to each activity 124 in a running process 122. For example, a workflow property may have the following configuration:
Name: Part_Number
Type: PARTNO
Label: Part Number.

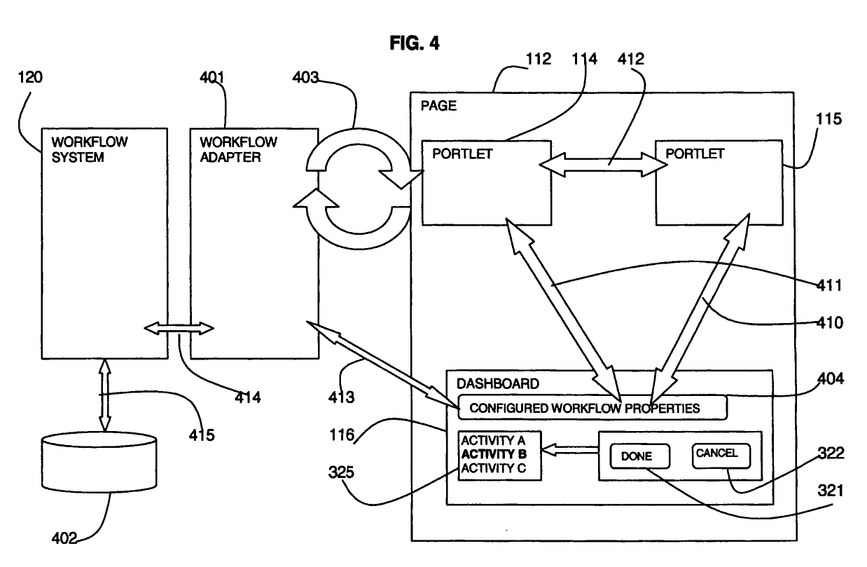

Referring to FIG. 4, a workflow system 120 has a workflow adapter 401 and a data storage means 402. A portal page 112 is shown during a running process 403. The portal page 112 has two portlets 114, 115 and a dashboard 116. The dashboard 116 has an indication 325 of the position of the current activity in the workflow process and action buttons for completion of the activity 321 and cancellation of the activity 322.

A workflow system 120 is capable of containing different kinds of messages. This allows the definition of actions like ‘approve’ and ‘decline’ in a workflow message. Based on the content of a message, the workflow process can be routed from one activity to certain other activities. A portal property broker allows rendering portal pages based on certain input parameters from the message. This allows the rendering of the action buttons 321, 322 in the user interface. The pressed action can also be submitted back to set the right value in the message.

The dashboard 116 also includes means for configuring workflow properties 404. These are properties of the workflow variables. The block arrows of FIG. 4 show the propagation of the properties between portlets 114, 115 and the workflow system 120. Workflow properties configured in the dashboard 116 can be communicated 410, 411 from the dashboard 116 to portlets 114, 115 in the portal page 112 and also between 412 cooperating portlets 114, 115. The properties are also communicated 413, 414 via the workflow adapter 401 to the workflow system 120 and stored 415 in the storage means 402.

Each instance of a workflow process 122 contains an identifier such as a GUID (global unique identifier) and a list of property name value pairs. The GUID is passed to the dashboard 116 via a parameter on the URL (Uniform Resource Locator) of the portal page 112. On opening of the portal page 112 the dashboard 116 records this GUID, giving it a context in which to communicate with the workflow system 120. The workflow system 120 provides APIs through which the dashboard 116 can communicate. For example:

To set a property value:
SetProperty(GUID workflowguid, String propertyname, Object PropertyValue)

To retrieve a property value:
Object GetProperty(GUID workflowguid, String propertyname)

The APIs provided by the workflow system 120 may be exposed to the dashboard 116 via Web Services or Enterprise Java beans, or other remote invocation mechanisms.

The dashboard 116 provides a configuration option 404 where a set of validation variables can be defined. Portlets 114, 115 within the page 112 of an activity are wired to the validation variables of the dashboard 116 and expected to set true values when they are in a valid state. An action with “enforce validation” setting will check each of the defined validation variables for true values before proceeding to inform the workflow to continue. A false value will produce a configured validation error message and the user's action will not proceed. All defined validation variables must be set true for the activity to be valid.

Actions may also enforce validation of components. An indication of whether the actions enforce validation of components 331 is shown in FIG. 3C.

In summary, an activity is represented by one or more portal pages which contain a dashboard used to interact with the workflow process. The portal pages contain portlets which can be wired to each other and to the dashboard to share properties and to indicate validity.

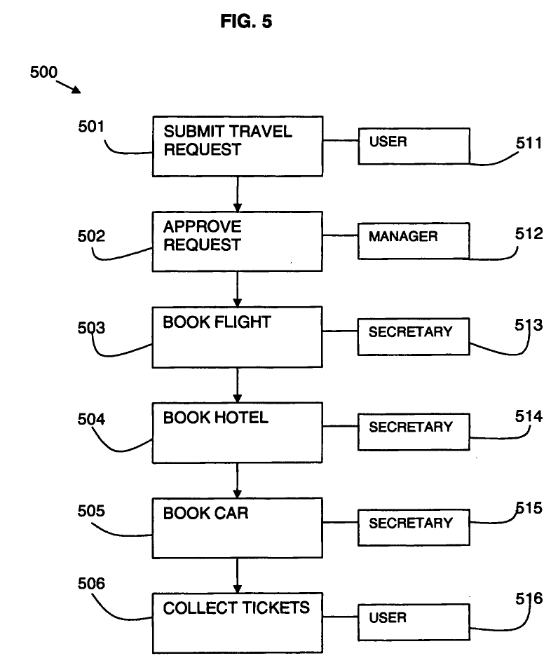

An example of a workflow process 500 is described with reference to FIG. 5 in which the workflow process is for making a travel booking in order to illustrate the operation of the described system.

The workflow process 500 of FIG. 5 includes the following activities with the designated activity assignee:
Submit travel request 501—User 511;
Approve request 502—Manager 512;
Book Flight 503—Secretary 513;
Book Hotel 504—Secretary 514;
Book Car 505—Secretary 515; and
Collect tickets 506—User 516.

Each of the steps 501-506 in the process 500 is linked to a page in a portal server; the page in the portal server contains one or more portlets, each of which can be used for a specific task.

For example, at step 503 of “Book Flight” an activity is to be completed by the secretary. First, the secretary is notified that this task exists as in a standard workflow and she opens the task and in doing so is taken directly to the portal page. The portal page may contain a number of portlets providing tools. The tools may include:
Search for flights;
Check flights comply with company travel policy;
Register passenger preferences;
Book Flight;
Check Weather; and
Chat tool to coordinate with requester via instant messaging.

The tools work in coordination with each other using the data associated with the workflow. For example, the weather tool may show the weather for the destination specified for the flight.

A workflow designer tool provides a facility to create a workflow process. Within this designer a list of activities are defined and linked based on the completion results of prior activities.

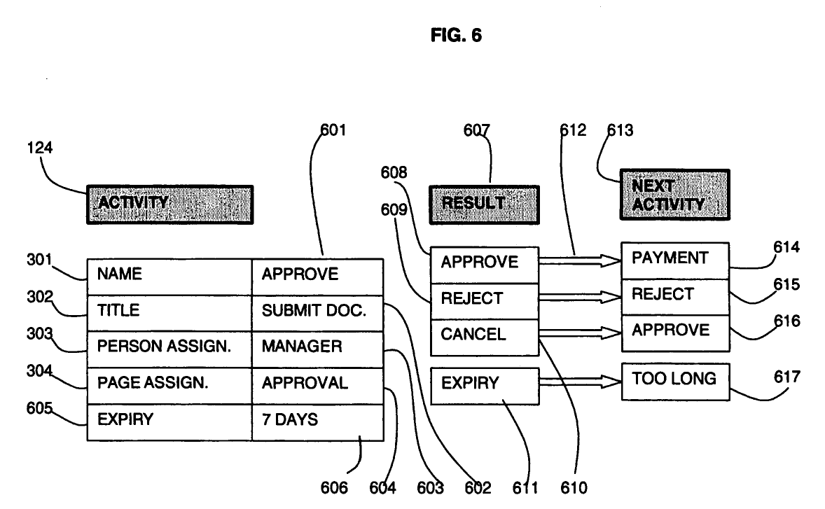

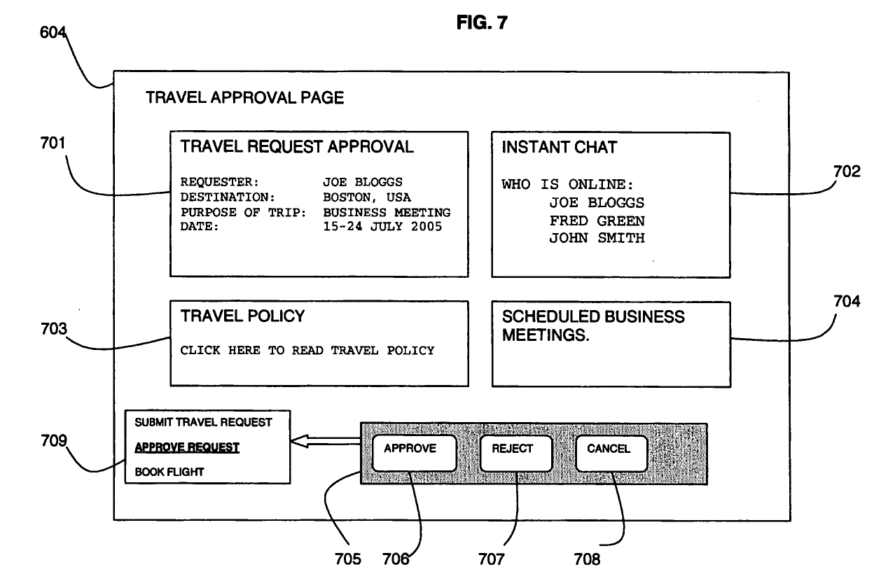

FIGS. 6 and 7 represent the definition of one activity within a process flow, in this case the “Approve” activity of step 502 of the process 500. Referring to FIG. 6, the activity 124 has the fields of name 301 which is “Approve” 601, title 302 which is “submit document” 602, person assignment 303 which is the “Manager” 603 and page assignment 304 which is the approval page 604 shown in FIG. 7. In addition there is an expiry field 605 which is set as “7 days” 606.

The approval page 604 shown in FIG. 7 has four portlets 701 to 704. A first portlet 701 provides details of the travel request as submitted in the previous activity of submitting the travel request. A second portlet 702 is an instant messaging portlet enabling the Manager to carry out instant messaging with other users regarding the request. A third portlet 703 provides a link to review travel policy. A fourth portlet 704 provides a calendar to review scheduled business meetings.

The approval page 604 also has a dashboard 705 including action buttons 706 to 708 enabling the Manager to “Approve” 706, “Reject” 707, or “Cancel” 708 the request. A representation 709 of the activities in the workflow 500 is provided indicating the position of the approval request activity 502 in the workflow 500.

The results 607 of the action buttons 706 to 708 available to the Manager in the dashboard 705 are shown in FIG. 6 as results 608 to 610 with the additional result of an expiry 611 of time if the Manager does not respond. The results 607 have pointers 612 to the next activity 613 in the workflow process which is activated in response to the result 607 of the approval request. If the request is approved 608, the next activity is payment 614. If the request is rejected 609, the next activity is a rejection 615 to the requester. If the request is cancelled 610, the next activity is to return to the approval activity 616. If the request expires 611, the next activity is to indicate an expiry to the requester.

The dashboard 705 is wired to the workflow system. The workflow process flows according to the workflow definition and the selected action button 706 to 708 from the dashboard 705, in the example, either Approve, Reject or Cancel.

The method of enforcing validation of workflow properties is illustrated using the first step in a travel request as shown in FIG. 5 of “Submit Travel Request” 501. The user is required to fill in fields Destination, Purpose of Trip and Date. If any of these fields are left blank the user should be prevented from submitting the request via the dashboard. A validation property “RequestFieldsValid” is configured on the dashboard and is available as a cooperative portlet input property. The Travel Request Approval Portlet 701 of FIG. 7 has an output property “FormValid” which is mapped to the “RequestFieldsValid” validation property on the dashboard. When the user fills in the fields of the travel request approval form, the travel request approval portlet validates the values and when satisfied sets the “FormValid” property to a true value thus via the mapping notifying the dashboard that it is valid to submit.

Data relevant to the process is carried through the workflow system and wired through to each component via the dashboard, using cooperative portlet technology.

Workflow technology is used in the context of portal pages. Portal pages are rendered specifically based on the content in a workflow message and the workflow is routed based on user interface interactions in the portlet.

Portals are currently the state of the art for low cost and central administrable user interfaces in enterprises. Therefore, there is significant value in using workflow system technology in combination with portals.

When a user receives an indication of work that needs to be done, instead of simply being informed of the task, or possibly provided with a link or application to perform the task, the described system provides for that linkage to be to a place with full capabilities, context and intercommunication. All of those three items are important and all exist because of a portal-like infrastructure. By capabilities, it is meant all related information is provided. This is expanded by context as all of the applications and related information are in a single place, and directly available. Then, the intercommunication provides an additional part since these pieces are all communicating together so that when any changes are made, those changes flow through all of the application's portlets in the portal page.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

What is claimed is:

1. A system for linking workflow to user input via a portal application, comprising:
a portal application having a plurality of portal pages;
a workflow system running a workflow process comprising a plurality of activities, wherein an activity in the workflow process is linked to a portal page;
a portal page having a user input portlet for inputting a result of the activity linked to the portal page; and
means for returning the result to the workflow system to determine a next activity in the workflow process.

2. A system as claimed in claim 1, wherein a portal page includes at least one portlet relating to the linked activity.

3. A system as claimed in claim 1, wherein the workflow system further comprises mapping means for mapping a result to the next activity in the workflow process.

4. A system as claimed in claim 1, wherein the user input portlet in a portal page includes means for inputting at least one property value relating to the activity linked to the portal page.

5. A system as claimed in claim 4, wherein the user input portlet includes means for transferring the at least one property value to the workflow system.

6. A system as claimed in claim 4, further comprising means for sharing the at least one property value between the user input portlet and at least one other portlet in the portal page.

7. A system as claimed in claim 4, wherein the user input portlet in a portal page includes means for receiving the at least one property value from the workflow system.

8. A system as claimed in claim 4, wherein the at least one property value is transferred between at least two portal pages relating to different activities via the workflow system.

9. A system as claimed in claim 4, wherein the at least one property value is validated and enforced by a result input by the user.

10. A system as claimed in claim 4, wherein an activity is linked to more than one portal page with one designated linked portal page for the activity.

11. A system as claimed in claim 1, wherein an activity in the workflow process has a Uniform Resource Locator (URL) to a portal page.

12. A system as claimed in claim 1, wherein an activity in the workflow process is assigned to a user or a group of users.

13. A system as claimed in claim 12, wherein the workflow system further includes notification means for notifying the assigned user or group of users of the activity to be performed.

14. A system as claimed in claim 1, wherein the user input portlet includes a visual indication of a position of the activity in the workflow process.

15. A system as claimed in claim 1, wherein the user input portlet includes means to configure the portlet to provide results for the linked activity.

16. A system as claimed in claim 1, wherein the workflow process includes a means for administrating the workflow process.

17. A system as claimed in claim 15, wherein the means for administrating the workflow process includes a user input portlet for inputting administration commands to the workflow system.

18. A method for linking workflow to user input via a portal application, the portal application having a plurality of portal pages, the method comprising:
providing a workflow process in a workflow system;
linking an activity in the workflow process to a portal page;
inputting a result of the activity via a user input portlet in the portal page;
returning the result of the activity to the workflow system; and
determining a next activity in the workflow process based on the returned result.

19. A method as claimed in claim 18, further including mapping a result to the next activity in the workflow process.

20. A method as claimed in claim 18, further including inputting at least one property value relating to the activity via the user input portlet.

21. A method as claimed in claim 20, wherein the at least one property value is transferred from the user input portlet to the workflow system.

22. A method as claimed in claim 20, wherein the at least one property value is shared between the user input portlet and at least one other portlet in the portal page.

23. A method as claimed in claim 20, further including receiving property values from the workflow system at a user input portlet in a portal page.

24. A method as claimed in claim 20, further including transferring the at least one property value between at least two portal pages relating to different activities via the workflow system.

25. A method as claimed in any claim 20, wherein the at least one property value is validated and enforced by a result input by the user.

26. A method as claimed in claim 20, wherein an activity is linked to more than one portal page with one designated linked portal page for the activity.

27. A method as claimed in claim 18, further including assigning at least one user to an activity.

28. A method as claimed in claim 27, further including notifying the at least one user of an activity to be performed.

29. A method as claimed in claim 18, further including configuring the user input portlet to provide results for the linked activity.

30. A method as claimed in claim 18, further including administrating the workflow process via a user input portlet.

31. A method as claimed in claim 30, wherein administrating the workflow process includes inputting administration commands to the workflow system.

32. A computer program product stored on a computer readable storage medium for linking workflow to user input via a portal application, the portal application having a plurality of portal pages, comprising computer readable program code means for performing the steps of:
providing a workflow process in a workflow system;
linking an activity in the workflow process to a portal page;
inputting a result of the activity via a user input portlet in the portal page;
returning the result of the activity to the workflow system; and
determining a next activity in the workflow process based on the returned result.
